(19) United States
(12) Patent Application Publication
(10) Pub. No.: US 2018/0073481 A1
(43) Pub. Date: Mar. 15, 2018

(54) GAS ENGINE IGNITION SYSTEM FOR EXTENDING LIFE AND LEAN LIMIT

(71) Applicant: Caterpillar Inc., Peoria, IL (US)

(72) Inventors: Jaswinder Singh, Dunlap, IL (US); David M. Ginter, Commerce Township, MI (US)

(73) Assignee: Caterpillar Inc., Peoria, IL (US)

(21) Appl. No.: 15/262,503

(22) Filed: Sep. 12, 2016

(51) Int. Cl. F02P 15/00; F02P 17/12

(52) U.S. Cl. CPC F02P 15/006; F02P 2017/121; F02P 17/12

(57) ABSTRACT

An ignition device and strategies are provided for extending spark plug life and air-fuel mixture lean limits in natural gas engines while maintaining or improving the engine thermal efficiency. The ignition device may include a plug body extending between a terminal end and an electrode end, a plurality of electrode pairs radially disposed on the electrode end each having an inner electrode and an outer electrode and an insulating body electrically isolating each of the electrode pairs from one another and each of the inner electrodes from the outer electrodes.

### TECHNICAL FIELD

The present disclosure relates generally to ignition systems for gas engines, and more particularly, to systems and methods for operating ignition devices at reduced voltages and reduced temperatures in lean burn applications.

### BACKGROUND

Internal combustion engines, or more particularly, natural gas engines, may be used to power various different types of machines, such as on-highway trucks or vehicles, off-highway machines, earth-moving equipment, generators, aerospace applications, pumps, stationary equipment such as power plants, and the like. Natural gas engines are typically supplied with a mixture of air and fuel, which is ignited at specific timing intervals using controlled electrical arcs that are created across a pair of electrodes of a spark plug. There are various ongoing efforts to reduce emissions as well as to improve efficiency, reliability and overall productivity of a natural gas engine. In natural gas engines, another common goal is to achieve an ignition and combustion arrangement that is able to run leaner, or with more air per volume of fuel, or where stoichiometric air-fuel mixture is mixed with exhaust gas circulation (EGR), at higher pressures for longer durations and with better combustion stability.

Spark plug aging is primarily determined by the breakdown voltage of the air-fuel mixture in the spark gap, which increases with increasing pressure, air-fuel ratio, and gap size. Leaner air-fuel mixtures have up to 50% higher breakdown voltage than stoichiometric air-fuel mixtures. The higher breakdown voltage results in more energy released during the spark event. The electrode temperatures increase, resulting in faster electrode erosion and increasing gap size. Eventually, the breakdown voltage increases beyond the voltage that the ignition system can deliver, resulting in misfires and combustion instability. As such, spark plug replacement intervals can be as short as 2000 hours in modern lean burn natural gas engines. Although adding more ignition points or spark plugs per cylinder may potentially help extend the spark plug replacement intervals, such arrangements may demand redesigned engine heads and ignition systems which would be costly to implement.

One option is to provide multiple ignition points within a single spark plug as disclosed in U.S. Pub. No. 2014/0076295 (“Zheng”). Specifically, Zheng discloses multiple high voltage electrodes which form multiple ignition points intended to promote the durability of spark plugs. Although Zheng may provide some benefits, there is still room for improvement. For instance, each of the multiple ignition points in Zheng still relies on the same ground electrode, and therefore, still subjects that ground electrode to uneven and increased wear over time. Additionally, the plurality of ignition points in Zheng do not do anything to alleviate the higher electrode voltages and higher combustion temperatures typical in lean burn natural gas engines. Furthermore, Zheng does not adapt ignition characteristics based on changes in spark plug health and/or engine operating conditions.

In view of the foregoing disadvantages associated with conventional ignition systems and devices, a need exists for more robust ignition solutions for natural gas engines that not only adjust the ignition scheme to extend the life of the ignition device, but also thereby allow for leaner and more stable combustions in natural gas engines. Correspondingly, there is also a need for a more robust ignition device that is capable of effectuating such adjustments and provide more stable combustions for longer durations. The present disclosure is directed at addressing one or more of the deficiencies and disadvantages set forth above. However, it should be appreciated that the solution of any particular problem is not a limitation on the scope of this disclosure or of the attached claims except to the extent expressly noted.

### SUMMARY OF THE DISCLOSURE

In one aspect of the present disclosure, an ignition device is provided. The ignition device may include a plug body extending between a terminal end and an electrode end, a plurality of electrode pairs radially disposed on the electrode end each having an inner electrode and an outer electrode, and an insulating body electrically isolating each of the electrode pairs from one another and each of the inner electrodes from the outer electrodes.

In another aspect of the present disclosure, a method of controlling an ignition device having a plurality of independently operable electrode pairs is provided. The method may include receiving one or more feedback signals from one or more sensor devices coupled to an engine, monitoring the feedback signals for one or more engine operating conditions, and selectively enabling one or more of the electrode pairs of the ignition device based on the engine operating conditions.

In yet another aspect of the present disclosure, an ignition system for an engine is provided. The ignition system may include at least one ignition device having a plurality of electrode pairs, at least one sensor device coupled to the engine and configured to generate feedback signals corresponding to one or more engine operating conditions, and a controller in electrical communication with each of the ignition device and the sensor device. The controller may be configured to monitor the engine operating conditions for one of a default condition, a lean condition and a breakdown condition, enable and designate one of the electrode pairs as the default electrode pair and disable the remaining electrode pairs when the default condition is identified, enable the default electrode pair and at least one of the remaining electrode pairs when the lean condition is identified, and disable the default electrode pair and enable and newly designate one of the remaining electrode pairs as the default electrode pair when the breakdown condition is identified.

These and other aspects and features will be more readily understood when reading the following detailed description in conjunction with the accompanying drawings.

### BRIEF DESCRIPTION OF THE DRAWINGS

FIG. 1 is a partial cross-sectional view of a combustion chamber and one ignition device constructed in accordance with the teachings of the present disclosure;

FIG. 2 is a planar view of an electrode end of one exemplary ignition device of the present disclosure;

FIG. 3 is cross-sectional side view of the ignition device of FIG. 2;

FIG. 4 is a planar view of an electrode end of another exemplary ignition device of the present disclosure;

FIG. 5 is cross-sectional side view of the ignition device of FIG. 4;

FIG. 6 is a diagrammatic view of one exemplary embodiment of an ignition system of the present disclosure;

FIG. 7 is a diagrammatic view of one exemplary controller that may be used with a ignition system of the present disclosure; and

FIG. 8 is a flow diagram of one exemplary algorithm or method of controlling an ignition device of the present disclosure.

While the following detailed description is given with respect to certain illustrative embodiments, it is to be understood that such embodiments are not to be construed as limiting, but rather the present disclosure is entitled to a scope of protection consistent with all embodiments, modifications, alternative constructions, and equivalents thereto.

### DETAILED DESCRIPTION

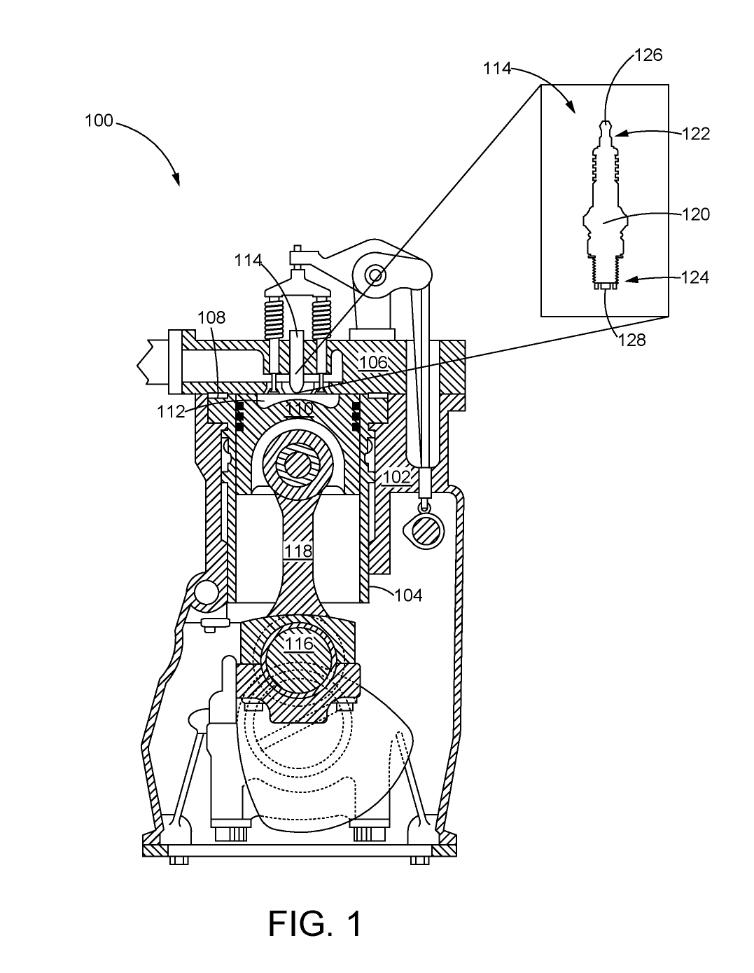

Referring to FIG. 1, a section of one exemplary internal combustion engine 100 is provided. Although the engine 100 shown may be used in a variety of different applications, the engine 100 and embodiments shown may be incorporated into machines, such as earth-moving machines or stationary work machines. For example, the engine 100 may be used to operate on-highway trucks, off-highway machines, earth-moving equipment, generators, aerospace applications, pumps, stationary equipment such as power plants, and the like. Additionally, the engine 100 may include any suitable internal combustion engine that uses air and fuel mixtures to generate mechanical power, such as rotational torque output, or the like. For example, the engine 100 may include a gasoline engine, a natural gas engine, or any other suitable internal combustion engine which employs spark plugs and related ignition devices for combustion.

As shown in FIG. 1, the engine 100 may include a block 102 defining one or more bores 104 which are substantially sealed using a head 106 and corresponding gasket 108. The engine 100 may also include a piston 110 slidably disposed within each bore 104 which defines a combustion chamber 112 with the head 106 and gasket 108. Furthermore, each combustion chamber 112 of the engine 100 may include one or more ignition devices 114 that are coupled to the head 106 and at least partially introduced into the combustion chamber 112. It will be understood that the engine 100 may include any number of combustion chambers 112 and that the combustion chambers 112 may be arranged in any number of different configurations, such as in an “in-line” configuration, in a “V” configuration, in an opposing-piston configuration, or the like.

The piston 110 in FIG. 1 may be configured to linearly reciprocate within the bore 104 between fully extended and fully retracted positions during a combustion event. For example, the piston 110 may be pivotally connected to a crankshaft 116 by way of a connecting rod 118 such that linear movement of the piston 110 between the fully extended and fully retracted positions causes the crankshaft 116 to rotate, and such that rotation of the crankshaft 116 causes the piston 110 to slide within the bore 104. Furthermore, during a combustion event, the piston 110 may be designed to travel through a plurality of strokes, including an intake stroke, a compression stroke, a power stroke, and an exhaust stroke. For example, fuel may be introduced into the combustion chamber 112 during the intake stroke, and mixed with air and ignited during the compression stroke. The resulting heat and pressure may then be converted into mechanical power during the power stroke, and residual gases may be discharged from the chamber 112 during the exhaust stroke.

As further shown in FIG. 1, the ignition device 114 may include a plug body 120, which extends between a terminal end 122 and an electrode end 124. Specifically, the ignition device 114 may be installed into the head 106 of the engine 100 such that the terminal end 122 is connectable to an electrical source and the electrode end 124 is introduced into the combustion chamber 112. Moreover, the terminal end 122 may include a terminal 126 that is configured to removably couple to one or more electrical sources, such as via ignition wires, or the like. The electrode end 124 may include a plurality of electrode pairs 128 that are configured to generate an electrical arc or a spark thereacross in response to voltage applied at the terminal end 122. Furthermore, connections to the terminal 126 at the terminal end 122 may provide for multiple and independent electrical connections to enable independent operation of the multiple electrode pairs 128.

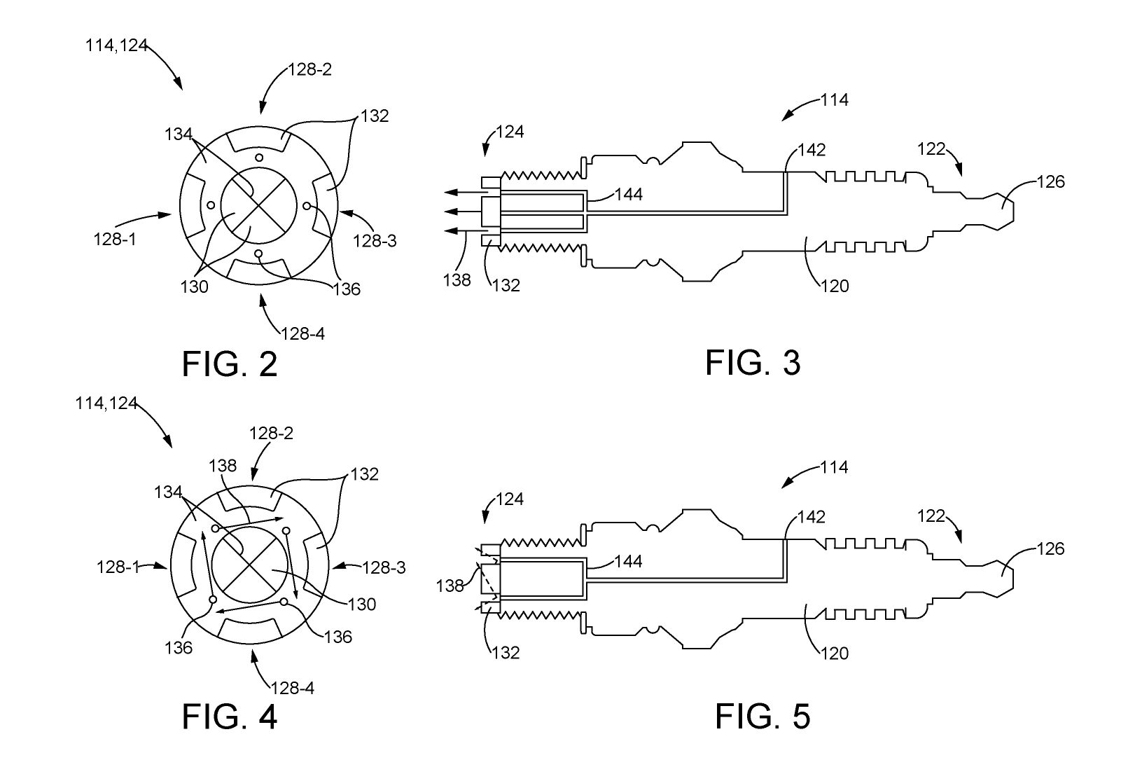

Turning to FIGS. 2-5, detailed views of one exemplary embodiment of the electrode end 124 of the ignition device 114 are shown. As shown, the electrode end 124 may include a plurality of electrode pairs 128, each having an inner electrode 130 and an outer electrode 132. In the embodiment shown in FIGS. 2-5, for example, the ignition device 114 may include four inner electrodes 130 radially positioned along a first or inner radius and four corresponding outer electrodes 132 radially positioned along a second or outer radius. Moreover, the inner electrodes 130 and outer electrodes 132 of each electrode pair 128 may at least partially extend through the surface of the electrode end 124 so as to form spark gaps that are equidistant to one another. Furthermore, each of the outer electrodes 132 may be electrically grounded while the corresponding inner electrodes 132 may be selectively charged with a positive voltage so as to create a voltage difference suited to induce an electrical arc across the spark gap.

Although the embodiment of FIGS. 2-5 depicts a radial arrangement of four electrode pairs 128, it will be understood that other shapes, configurations and arrangements may be employed. For example, fewer or more than four electrode pairs 128 may be employed per electrode end 124. The electrode pairs 128 may also be provided in arrangements other than the circular or radial arrangements shown, such as in oval, elliptical, rectangular, square, triangular or other suitable arrangements. Additionally, the electrode pairs 128 may employ other voltage polarities than described. For example, the inner electrodes 130 may be grounded while the outer electrodes 132 are positively charged, or the inner electrodes 130 may be negatively charged while the outer electrodes 132 are grounded. In other embodiments, neither electrode 130, 132 may be grounded, or both electrodes 130, 132 may be charged so long as a sufficient potential voltage difference is created therebetween.

Still referring to FIGS. 2-5, the ignition device 114 may also include an insulating body 134 configured to electrically insulate or isolate each of the inner electrodes 130 from the outer electrodes 132, as well as to electrically isolate each of the electrode pairs 128 from one another. Moreover, the insulating body 134 may be radially disposed in between the inner electrode 130 and the outer electrode 132 for each electrode pair 128, and further, circumferentially configured to electrically separate the inner electrodes 130 and outer electrodes 132 of adjacent electrode pairs 128. In the embodiment of FIGS. 2-5 for example, each of the inner electrodes 130 may be independently supplied with its own positively charged voltage through the terminal 126, and each of the outer electrodes 132 may be independently grounded. The arrangement and geometry of the electrode end 124 may thereby enable the independent control of each electrode pair 128 and prevent sparks from forming between mismatched or adjacent electrodes 130, 132.

As shown in FIGS. 2-5, the ignition device 114 may additionally include a plurality of orifices 136 on the electrode end 124 configured to locally enrich the ignition points of the ignition device 114. In particular, the orifices 136 may be radially disposed on the electrode end 124 and configured to introduce streams of gas or fuel jets 138 that are directed into the combustion chamber 112, but concentrated near the spark gaps created by each electrode pair 128. For instance, each orifice 136 may be disposed proximate to and/or radially in between the inner electrode 130 and the outer electrode 132 of a corresponding electrode pair 128, so as to introduce a fuel jet 138 substantially in line with the anticipated spark. Localized enrichment may facilitate faster combustion of the fuel and air mixture, such as in lean burn gas engines, and also allows for lower electrode voltages to ignite relatively richer air-fuel mixtures near the electrode pairs 128, and hence reduced electrode temperatures and erosion, and an overall improvement to the life of the electrodes 130, 132 and the ignition device 114. Additionally, faster combustion of leaner air-fuel mixtures, made possible by enriched fuel bodies localized to the electrode pairs 128, may help improve combustion efficiency and reduce the emission of pollutants from the engine 100.

Each orifice 136 in FIGS. 2-5 may be designed to inject a fuel jet 138 at an angle, direction or distance which optimizes and facilitates combustion. In FIGS. 2 and 3 for example, the orifices 136 may be radially positioned in between and directly in line with the corresponding electrode pairs 128. Accordingly, the orifices 136 in FIGS. 2 and 3 may be configured to generate a fuel jet 138 at an angle that is substantially perpendicular to the electrode end 124. Alternatively, in FIGS. 4 and 5 for example, the orifices 136 may be radially positioned in between the corresponding electrode pairs 128, but offset from the spark gap and the anticipated path of the spark. However, the orifices 136 in FIGS. 4 and 5 may be configured to generate a fuel jet 138 that is directed at an acute angle relative to the electrode end 124 and designed to coincide with the anticipated path of the spark. Although not shown, it will be understood that fewer or more orifices 136 and/or other arrangements of orifices 136 may be used to produce similar results.

Still referring to FIGS. 2-5, the gas supplied by the orifices 136 may be delivered from a fuel source 140, such as fuel pumps, fuel rails, fuel tanks or reservoirs, fuel lines, or combinations thereof, any of which may be separately provided or already integrated with the engine 100. The fuel source 140 may be in fluid communication with each ignition device 114, for example, via one or more inlet ports 142 that may be provided on the plug body 120 of the ignition device 114. A single or a network of channels 144 may also be formed within each ignition device 114 which directs fuel from the inlet ports 142 to the orifices 136. In addition, the diameters and lengths of the inlet ports 142, channels 144 and/or orifices 136 may be configured to passively introduce substantially consistent fuel jets 138 into the combustion chamber 112. One or more of the orifices 136 may also be individually or actively controlled. Furthermore, the inlet ports 142, channels 144 and orifices 136 may collectively supply approximately 1-2%, or any other suitable amount, of the fuel normally introduced into the combustion chamber 112 at a pre-calibrated time and for a pre-calibrated duration close to the spark ignition event.

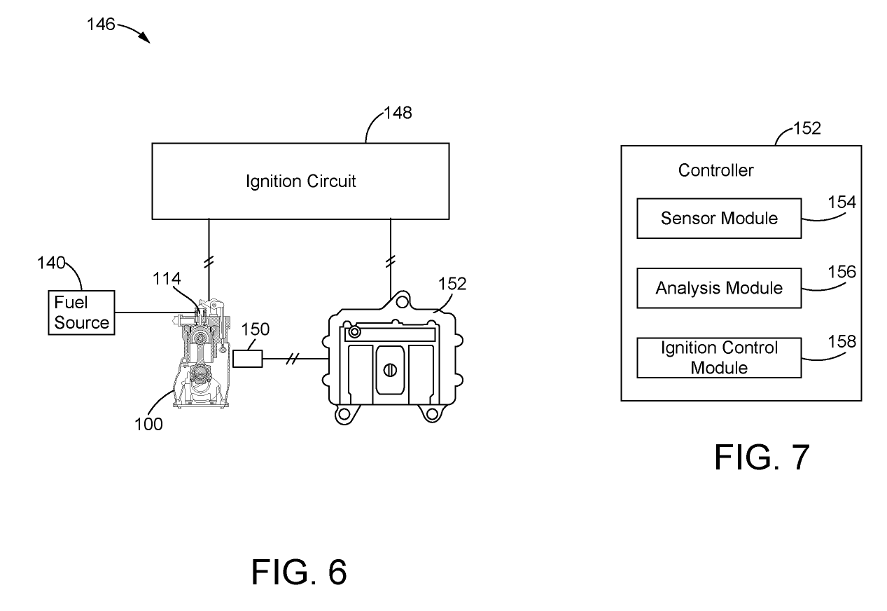

Referring now to FIG. 6, one exemplary embodiment of an ignition system 146 which may be used to operate one or more ignition devices 114 is diagrammatically provided. As shown, the ignition system 146 may be implemented in relation to the engine 100 and an ignition circuit 148 associated therewith. As is commonly understood in the art, the ignition circuit 148 may be configured to control the timing of the ignition or the magnitude and frequency of the voltage applied to the ignition device 114. For instance, the ignition circuit 148 may include one or more ignition coils, such as a transformer with a primary winding which converts electrical supply signals into appropriate voltage signals at a secondary winding, for operating the ignition devices 114. Moreover, the secondary transformer voltage, or the voltage supplied by the secondary winding of a transformer of the ignition circuit 148, may be used to generate the electrical arc or spark at the electrode ends 124 of the ignition devices 114.

As shown in FIG. 6, the ignition system 146 may include the ignition devices 114, one or more sensor devices 150 and a controller 152 in electrical communication with each of the ignition devices 114, such as via the ignition circuit 148, and the sensor devices 150. The sensor devices 150 may be coupled to the engine 100 and configured to generate feedback signals corresponding to one or more engine operating conditions. For example, the sensor devices 150 may be configured to generate feedback signals based on various information collected from the engine 100, including one or more of air-to-fuel ratios, engine loads, engine speeds, combustion quality, detected misfires, and any other information that may be related to the operation of the ignition devices 114. Any one or more of the sensor devices 150 may be preexisting and already integrated in the engine 100 and/or an engine management or control unit associated therewith.

Although the controller 152 of FIG. 6 may be separately provided, it will be understood that the controller 152 may also be at least partially integrated within any preexisting engine management or control unit associated with the engine 100. The controller 152 may be implemented using one or more of a processor, a microprocessor, a microcontroller, an engine control module (ECM), an engine control unit (ECU), and any other suitable device for communicating with any one or more of the sensor devices 150, the ignition devices 114, or at least the ignition circuit 148 associated with the ignition devices 114. In general, the controller 152 may be configured to operate according to predetermined algorithms or sets of logic instructions designed to manage the ignition system 146, monitor the feedback signals for various engine operating conditions, and appropriately adjust operation of the ignition devices 114, or the electrode pairs 128 thereof, based on the detected operating conditions.

Turning to FIG. 7, one exemplary embodiment of a controller 152 that may be used with the ignition system 146 is diagrammatically provided. As shown, the controller 152 may be configured to function according to one or more preprogrammed algorithms, which may be generally categorized into, for example, a sensor module 154, an analysis module 156, and an ignition control module 158. The controller 152 may additionally include access to any memory, such as local on-board memory and/or memory remotely situated from the controller 152, for at least temporarily storing any one or more of the algorithms, engine data, predefined thresholds, and other logic instructions. It will be understood that the arrangement of grouped code or logic instructions shown in FIG. 7 merely demonstrate one possible way to implement and perform the functions of the ignition system 146, and that other comparable arrangements are possible. For instance, one or more of the modules in FIG. 7 may be modified, merged and/or omitted and still provide comparable results.

Initially, the sensor module 154 of FIG. 7, may be configured to receive one or more feedback signals from the one or more sensor devices 150 coupled to the engine 100. The analysis module 156 may be configured to monitor the feedback signals for one or more predefined engine operating conditions. For example, the analysis module 156 may configure the controller 152 to monitor for one of a default condition, a lean condition, a breakdown condition, or any other condition relevant to the operation of the ignition devices 114. A default condition may be identified when the feedback signals indicate that the engine 100 is operating under normal operating conditions, or conditions typical of gas engines 100 operating at less than full load, at steady state, under typical emissions restraints, and the like. Moreover, the default condition may indicate typical operating conditions where a single ignition point is sufficient.

The analysis module 156 of FIG. 7 may further configure the controller 152 to identify other events or conditions which may be alleviated by selectively enabling one or more of the electrode pairs 128 of the ignition devices 114. The lean condition may be identified when the feedback signals indicate one or more of transient load conditions, full load conditions, ultra-lean operating modes, low emission operating modes or more stringent emissions restraints, and the like. Such conditions may suggest a need for even leaner burns and thereby a need for multiple ignition points along with appropriate levels of localized enrichment with natural gas stream. Furthermore, the breakdown condition may be identified when the feedback signals indicate that a voltage across the default electrode pair 128, or the electrode pair 128 currently in use, exceeds an acceptable voltage range or predefined threshold. Such a condition may indicate that the electrodes 130, 132 currently in use are worn out, deteriorated, corroded, or otherwise insufficient to maintain stable and efficient combustion.

Based on the engine operating conditions observed by the analysis module 156, the ignition control module 158 of FIG. 7 may configure the controller 152 to adjust control of the electrode pairs 128 of the ignition devices 114, such as via the ignition circuit 148. More particularly, if a default condition is identified, the ignition control module 158 may enable and designate as default one of the electrode pairs 128, such as electrode pair 128-1 of the ignition device 114 of FIGS. 2-5, and disable the remaining electrode pairs 128-2, 128-3, 128-4. For example, the controller 152 may enable voltage only across the default electrode pair 128-1 to create a spark and ignite the fuel and air mixture within the associated combustion chamber 112 with the help of localized fuel enrichment, and leave the remaining electrode pairs 128-2, 128-3, 128-4 unused or in a standby mode, until changes in engine operating conditions suggest otherwise.

If, however, a lean condition is identified, the ignition control module 158 of FIG. 7 may configure the controller 152 to enable the default electrode pair 128-1 and at least one of the remaining electrode pairs 128-2, 128-3, 128-4. Moreover, the ignition control module 158 thereby provides two or more ignition points for the given combustion chamber 112 when transient load conditions, full load conditions, ultra-lean operating modes, low emission operating modes, or any other condition that may benefit from leaner burns exist. All of these above cases may further be supported by localized fuel enrichment using a natural gas stream. In particular, the controller 152 may operate the ignition circuit 148 to apply voltage simultaneously across two or more electrode pairs 128 per ignition device 114 until the subsequent engine operating conditions suggest otherwise. Additionally, when a lean condition is identified, the controller 152 may select electrode pairs 128 that are positioned adjacent to one another or across from one another.

Furthermore, if a breakdown condition is identified, or when the electrode pair 128-1 currently in use or designated as the default is deteriorating, the ignition control module 158 of FIG. 7 may configure the controller 152 to enable and designate one of the remaining electrode pairs 128-2, 128-3, 128-4 as the new default electrode pair 128-2. Correspondingly, the electrode pair 128-1 previously designated as default may be discontinued from further use. Similarly, once a breakdown condition is identified for the new default electrode pair 128-2, one of the then remaining electrode pairs 128-3, 128-4 may be enabled and designated as the new default ignition point, and so on. Such a routine may be repeated until all remaining electrode pairs 128 have been used as a default ignition point. Once all electrode pairs 128 of a given ignition device 114 have been consumed, the ignition device 114 may be replaced, and any associated breakdown counters within the ignition control module 158 or controller 152 may be reset. For example, this feature may increase the life span of the ignition device 114 by four times or more.

As indicated above with respect to FIGS. 2-5, the ignition devices 114 may further include orifices 136 configured to introduce fuel jets 138 of gas into the anticipated path of the electrical arc created between the electrode pairs 128. While the fuel jets 138 may be passively supplied, in other embodiments, it will be understood that the orifices 136 and/or fuel jets 138 may also be actively controlled by the controller 152. If such localized enrichment is available, either passively or actively, the controller 152 may be able to also adjust control of the ignition circuit 148 and drive the electrode pairs 128 at substantially reduced voltages whenever localized enrichment is enabled. Correspondingly, the controller 152 may expose the electrodes 130, 132 to reduced spark temperatures and reduced electrode erosion, thereby prolonging the life of not only the individual electrodes 130, 132, but also the life of the ignition devices 114. Specifically, localized enrichment may enable the spark to propagate faster, from one or more electrode pairs 128 and into the leaner air-fuel mixtures in the combustion chamber, and thus help improve combustion efficiency of leaner air-fuel mixtures while reducing undesired emissions, such as nitrogen oxide (NOx) emissions.

### INDUSTRIAL APPLICABILITY

In general, the present disclosure finds utility in various applications, such as on-highway trucks or vehicles, off-highway machines, earth-moving equipment, generators, aerospace applications, pumps, stationary equipment such as power plants, and the like, and more particularly, provides an improved electrode design which prolongs the life of ignition device and overcomes lean burn limits in gas engines. Moreover, the present disclosure provides multiple and independently operable electrode pairs which provide redundant and supplemental ignition points for use in various conditions. The present disclosure also provides localized enrichment which reduces electrode voltages and overall temperatures to minimize the effects of corrosion and other natural electrode defects. The present disclosure also provides ignition control schemes which selectively adjust control of the electrodes based on engine operating conditions.

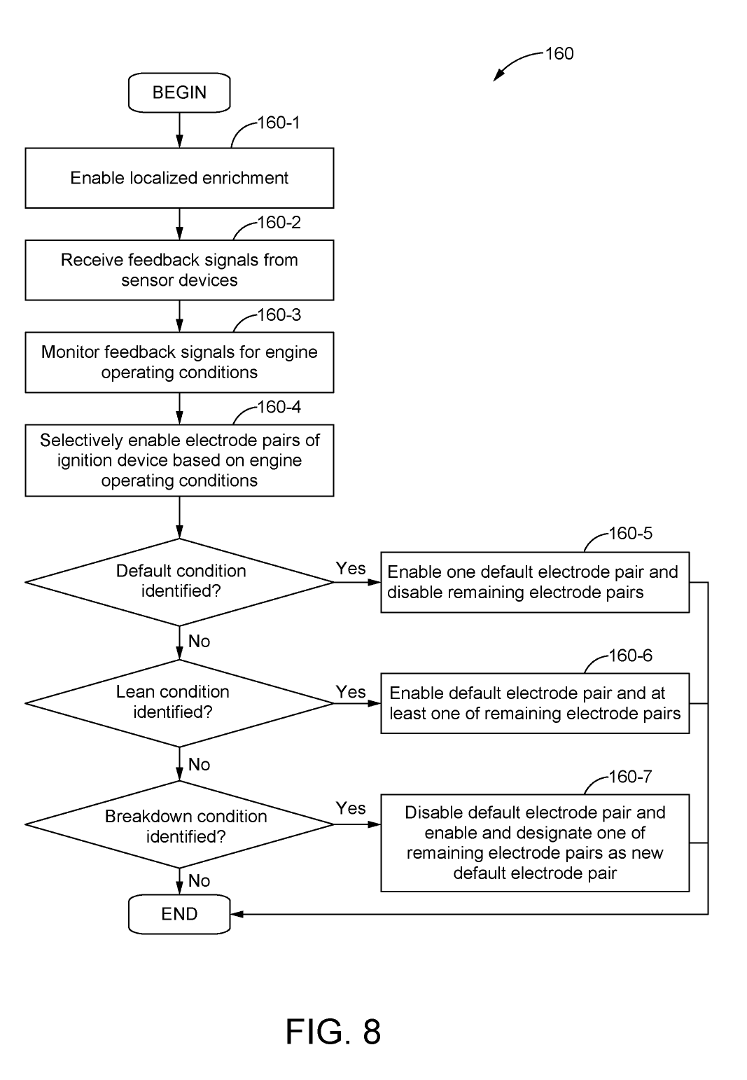

Turning to FIG. 8, one exemplary algorithm or method 160 of controlling or operating the ignition system 146 and the ignition device 114 is provided. In particular, the method 160 may be implemented in the form of one or more algorithms, instructions, logic operations, or the like, and the individual processes thereof may be performed or initiated via the controller 152. As shown in block 160-1, if applicable, the method 160 may initially enable a localized enrichment feature, or supply gas or fuel jets 138 through one or more orifices 136 positioned proximate to each of the electrode pairs 128. Furthermore, because localized enrichment facilitates combustion, the method 160 may correspondingly supply a reduced voltage across each enabled electrode pair 128. While the fuel jets 138 may generally be introduced passively, in other modifications, one or more of the fuel jets 138 may be actively controlled such as via the controller 152 of FIGS. 6 and 7, or the like.

As shown in FIG. 8, the method 160 in block 160-2 may also receive one or more feedback signals from one or more sensor devices 150 associated with the engine 100. The feedback signals may include various information collected from the engine 100, such as one or more of air-to-fuel ratios, engine loads, engine speeds, combustion quality, detected misfires, and any other information that may be related to the operation of the ignition devices 114. Moreover, the feedback signals may include information that can be used to determine the operating state or condition of the engine 100 at a given moment. Correspondingly, the method 160 in block 160-3 may monitor the feedback signals for various engine operating conditions. Based on the identified engine operating conditions, the method 160 in block 160-4 may then selectively enable or disable one or more of the electrode pairs 128 of the ignition devices 114.

In particular, the method 160 in FIG. 8 may monitor for one of three engine operating conditions, including a default condition, a lean condition and a breakdown condition. As discussed above with respect to the controller 152 of FIG. 7, a default condition may be identified when the feedback signals indicate that the engine 100 is operating under normal operating conditions, or conditions typical of gas engines 100 operating at less than full load, at steady state, under typical emissions restraints, and the like. The default condition may indicate typical operating conditions where a single ignition point is sufficient. If such a default condition is identified, the method 160 in block 160-5 may enable and designate as default one of the electrode pairs 128, such as electrode pair 128-1 of the ignition device 114 of FIGS. 2-5, and disable the remaining electrode pairs 128-2, 128-3, 128-4 for at least the given cycle or iteration and until subsequent reiterations suggest otherwise.

A lean condition may be identified in block 160-4 of FIG. 8 when the feedback signals indicate one or more of transient load conditions, full load conditions, ultra-lean operating modes, low emission operating modes or more stringent emissions restraints, and the like. Such conditions may suggest a need for even leaner burns and thereby a need for multiple ignition points. If a lean condition is identified, the default electrode pair 128-1 and at least one of the remaining electrode pairs 128-2, 128-3, 128-4 may be enabled for at least the given cycle or iteration per block 160-6. The method 160 thereby provides two or more ignition points for the given combustion chamber 112 when transient load conditions, full load conditions, ultra-lean operating modes, low emission operating modes, or any other condition that may benefit from leaner burns exist. In particular, the method 160 may apply voltage simultaneously across two or more electrode pairs 128 per ignition device 114 until the subsequent engine operating conditions suggest otherwise.

A breakdown condition may be identified by the method 160 in FIG. 8 when the feedback signals indicate that a voltage across the default electrode pair 128, or the electrode pair 128 currently in use, exceeds an acceptable voltage range or predefined threshold. Such a condition may indicate that the electrodes 130, 132 currently in use are worn out, deteriorated, corroded, or otherwise insufficient to maintain stable and efficient combustion. If a breakdown condition is identified, or when the electrode pair 128-1 currently in use or designated as the default is deteriorating, the method 160 in block 160-7 may enable and designate one of the remaining electrode pairs 128-2, 128-3, 128-4 as the new default electrode pair 128-2, and discontinue the electrode pair 128-1 previously designated as default from further use. This routine may be repeated until all remaining electrode pairs 128 have been consumed, at which point the ignition device 114 may be replaced and the method 160 may be reset.

It will be understood that other variations of the processes shown in the method 160 of FIG. 8 are possible and can produce similar results. For instance, any combination of the processes shown in FIG. 8 may be simultaneously performed or performed in sequences other than may be suggested in FIG. 8. The localized enrichment feature may also be omitted as an active process in ignition devices designed to passively introduce localized gas into the combustion chamber 112. Alternatively, the localized enrichment feature may also be continuously performed throughout the other processes shown in FIG. 8. Furthermore, the method 160 may be configured to monitor for fewer or more conditions than identified in FIG. 8. Still further, any one or more of the processes shown in FIG. 8 may be reiteratively performed according to predefined sampling or signal processing frequencies, combustion cycles, or any other frequency that may be suited for the given application.

From the foregoing, it will be appreciated that while only certain embodiments have been set forth for the purposes of illustration, alternatives and modifications will be apparent from the above description to those skilled in the art. These and other alternatives are considered equivalents and within the spirit and scope of this disclosure and the appended claims.

What is claimed is:

1. An ignition device, comprising:
a plug body extending between a terminal end and an electrode end;
a plurality of electrode pairs radially disposed on the electrode end each having an inner electrode and an outer electrode; and
an insulating body electrically isolating each of the electrode pairs from one another and each of the inner electrodes from the outer electrodes.

2. The ignition device of claim 1, further comprising a plurality of orifices radially disposed on the electrode end.

3. The ignition device of claim 2, wherein each orifice is radially disposed between the inner electrode and the corresponding outer electrode of one of the electrode pairs and configured to supply a gas therethrough.

4. The ignition device of claim 2, wherein the electrode end includes four orifices and four corresponding electrode pairs, the inner electrode of each electrode pair being radially disposed along a first radius of the electrode end and the outer electrode of each electrode pair being radially disposed along a second radius of the electrode end, the first radius being less than the second radius, the orifices being radially disposed between the inner electrodes and the outer electrodes.

5. The ignition device of claim 1, wherein each of the electrode pairs at least partially extends through the electrode end and the plug body.

6. The ignition device of claim 1, wherein each electrode pair forms a spark gap between the inner electrode and the outer electrode, the spark gap of each electrode pair being equidistant.

7. The ignition device of claim 6, wherein each electrode pair is configured to receive a reduced voltage across the inner electrode and the outer electrode.

8. The ignition device of claim 1, wherein the outer electrodes are independently grounded and the inner electrodes are independently supplied with a voltage applied at the terminal end.

9. The ignition device of claim 1, wherein the inner electrode of each electrode pair is radially disposed along a first radius of the electrode end and the outer electrode of each electrode pair is radially disposed along a second radius of the electrode end, the first radius being less than the second radius.

10. A method of controlling an ignition device having a plurality of independently operable electrode pairs, comprising:
receiving one or more feedback signals from one or more sensor devices coupled to an engine;
monitoring the feedback signals for one or more engine operating conditions; and
selectively enabling one or more of the electrode pairs of the ignition device based on the engine operating conditions.

11. The method of claim 10, further comprising:
supplying a gas through an orifice positioned between each of the electrode pairs; and
supplying a reduced voltage across each of the electrode pairs that are enabled.

12. The method of claim 10, wherein the feedback signals are monitored for a default condition that is identified during normal operating conditions, one of the electrode pairs being enabled and designated as the default electrode pair and the remaining electrode pairs being disabled when the default condition is identified.

13. The method of claim 12, wherein the feedback signals are monitored for a lean condition that is identified during one or more of transient load conditions, full load conditions, low emission operating modes, and ultra-lean operating modes, the default electrode pair and at least one of the remaining electrode pairs being enabled when the lean condition is identified.

14. The method of claim 12, wherein the feedback signals are monitored for a breakdown condition that is identified when a voltage across the default electrode pair exceeds an acceptable voltage range, the default electrode pair being disabled and one of the remaining electrode pairs being enabled and newly designated as the default electrode pair when the breakdown condition is identified.

15. The method of claim 10, wherein the feedback signals correspond to one or more of air-to-fuel ratios, engine loads, engine speeds, combustion quality, and misfires.

16. An ignition system for an engine, comprising:
at least one ignition device having a plurality of electrode pairs;
at least one sensor device coupled to the engine and configured to generate feedback signals corresponding to one or more engine operating conditions; and
a controller in electrical communication with each of the ignition device and the sensor device, the controller configured to monitor the engine operating conditions for one of a default condition, a lean condition and a breakdown condition, enable and designate one of the electrode pairs as the default electrode pair and disable the remaining electrode pairs when the default condition is identified, enable the default electrode pair and at least one of the remaining electrode pairs when the lean condition is identified, and disable the default electrode pair and enable and newly designate one of the remaining electrode pairs as the default electrode pair when the breakdown condition is identified.

17. The ignition system of claim 16, wherein the ignition device includes an orifice disposed between each of the electrode pairs, and the controller is configured to supply a gas through each orifice, and supply a reduced voltage across each of the electrode pairs that are enabled.

18. The ignition system of claim 16, wherein the default condition is identified during normal operating conditions.

19. The ignition system of claim 16, wherein the lean condition is identified during one or more of transient load conditions, full load conditions, low emission operating modes, and ultra-lean operating modes.

20. The ignition system of claim 16, wherein the breakdown condition is identified when a voltage across the default electrode pair exceeds an acceptable voltage range.
